(19) United States
(12) Patent Application Publication
(10) Pub. No.: US 2006/0027303 A1
(43) Pub. Date: Feb. 9, 2006

(54) Method and system for manufacturing laminated cartons

(75) Inventor: Robert J. Hunter, Woodstock, GA (US)

Correspondence Address: WOMBLE CARLYLE SANDRIDGE & RICE, PLLC, P.O. BOX 7037, ATLANTA, GA, 30357-0037, US

(73) Assignee: Graphic Packaging International, Inc.

(21) Appl. No.: 10/912,295

(22) Filed: Aug. 5, 2004

(51) Int. Cl. B32B 37/00; B32B 38/00

(52) U.S. Cl. 156/64; 156/250; 156/357; 156/256

(57) ABSTRACT

A method and system for manufacturing laminated cartons, in which webs of carton materials are fed along paths of travel toward a laminating station. A sensor reads printed indicia along a first one of the webs and controls application of adhesive to the second web for attaching the webs to form laminated sheets of carton material.

### FIELD OF THE INVENTION

The present invention generally relates to the manufacture of cartons, and in particular, to an improved system and method for manufacturing laminated cartons including the controlled application of adhesive between sheets of carton materials to be laminated together.

### BACKGROUND OF THE INVENTION

Paperboard cartons, and in particular reinforced cartons made from laminated paperboard or other carton material sheets have become increasingly popular containers for the packaging, transport, and storage for products such as beverage cans, bottles, frozen foods, and various other types of products grouped and sold together. Typically, such cartons are manufactured by gluing two or more sheets or strips of material, such as paperboard, together to form laminated sheets from which carton blanks are cut or stamped. In the past, during the lamination process, glue generally has been applied substantially continuously between the sheets of carton material. Such an operation typically results in considerable waste and expense, especially where more expensive hot melt adhesives are required to be used, as the adhesive generally is applied substantially continuously over the surface of the two sheets. In such conventional laminating systems or lines, the gluing costs are typically one of the most significant expenses of the manufacturing process, and not only is an excess of glue or adhesive applied that is typically more than is needed to securely attach the sheets together, the portions of the glue applied at the areas of the cartons that are later cut out will be thrown out with the waste scrap carton material. These laminated carton scraps also often times cannot be recycled due to the coating of glue therebetween. Still further, the excess of glue can adversely affect the downstream cutting or stamping equipment as it is squeezed or otherwise dislodged from between the carton edges during cutting.

Recently, systems have been developed for monitoring and controlling the application of adhesive to sheet materials. These systems generally include a sensor that reads a printed mark on a sheet and, in response, causes the application of glue to the sheet. Such systems, however, are not designed to read unprinted substrate or control the application of adhesive to reinforcing materials other than the printed sheet that is being monitored by the sensor.

Accordingly, it can be seen that a need exists for an improved system and method for forming laminated carton materials that addresses the foregoing and other related and unrelated problems in the art.

### SUMMARY OF THE INVENTION

Briefly described, the present invention generally comprises a method and system for forming laminated sheet materials from which laminated or reinforced cartons or carton blanks can be formed. The present invention may comprise a laminating line along which at least two webs or sheets of the carton material, such as paperboard, cardboard, plastics or synthetics, or other carton materials may be fed. Each web may be fed along a separate path of travel toward a laminating station. A first one of the webs of carton material generally may be a printed web, including one or more colored sections or backgrounds, printed graphics such as photos, text, etc. The first web also can include a series of ink marks or registration marks along the side or transition portions adjacent different printed sections of the web. A sensor may be positioned along the path of travel of the first or printed web in a position to monitor and read the printing on the first web. For example, the sensor can be programmed to detect a transition edge between printed panels or sections of the web, to look for registration or ink marks, or to monitor color delineations or bands on the printed web.

Substantially simultaneously with the movement of the first web along its path of travel, the second web may be moved along its path of travel toward the laminating station and engagement with the first web. A series of operative stations, including an adhesive station, having one or more adhesive applicators, a cutting station, a printing station or head, and/or various combinations thereof, generally may be provided along the second path of travel, followed by the second web. The second web typically can be formed from the same or a similar material to the first web, i.e., paperboard, cardboard, plastics, or other conventional carton or reinforcing materials, and also can be formed as one or more strips having a width less than that of the first web.

In response to the detection of printing, marks, or other indicia on the first or printed web by the sensor, the control system for the laminating line may in turn actuate one or more of the operative stations, such as the adhesive station, for applying adhesive at selected points along the second web. The control system may control the application of the adhesive to apply adhesive where needed to ensure proper adhesion between the first and second web, especially at the edges thereof, with the amount of adhesive being controlled so as to minimize waste. Thereafter, the first and second webs may be passed through the laminating station, which will urge the webs into tight adhesive contact to form the laminated carton sheet material from which carton blanks can be stamped, cut, or otherwise formed.

Various objects, features, and advantages of the present invention will become apparent to those skilled in the art upon review of the following detailed description when taken in conjunction with the accompanying drawings.

### BRIEF DESCRIPTION OF THE DRAWINGS

FIG. 1A is a side view schematically illustrating the process of the laminating system of an embodiment of the present invention.

FIG. 1B is a perspective view schematically illustrating another embodiment of the present invention.

FIG. 2 is a perspective view schematically illustrating still another embodiment of the laminating system of the present invention.

FIG. 3 is an exploded perspective view illustrating a carton blank formed by an embodiment of the present invention.

### DETAILED DESCRIPTION OF THE INVENTION

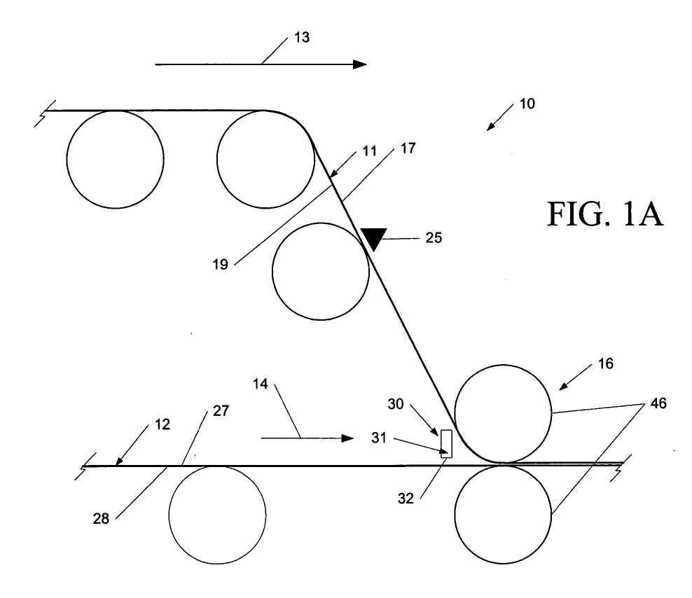

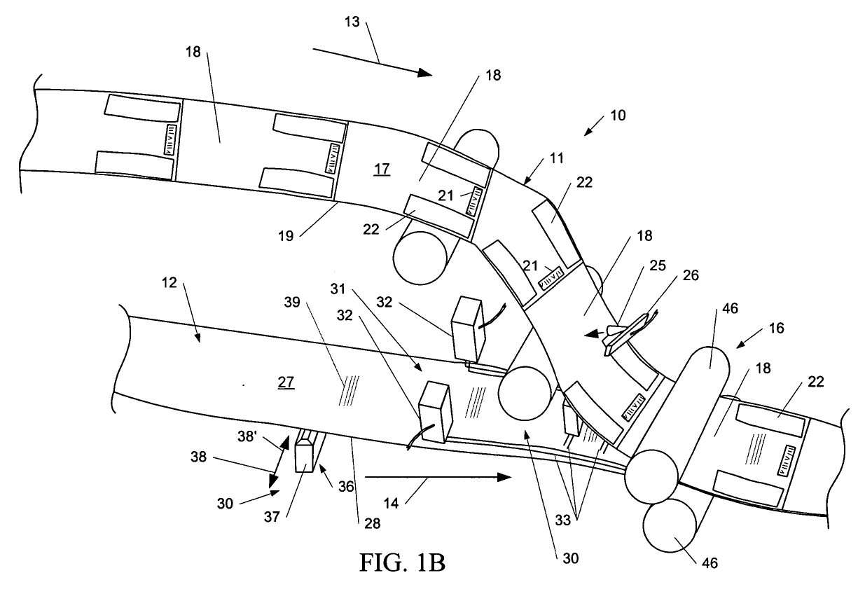

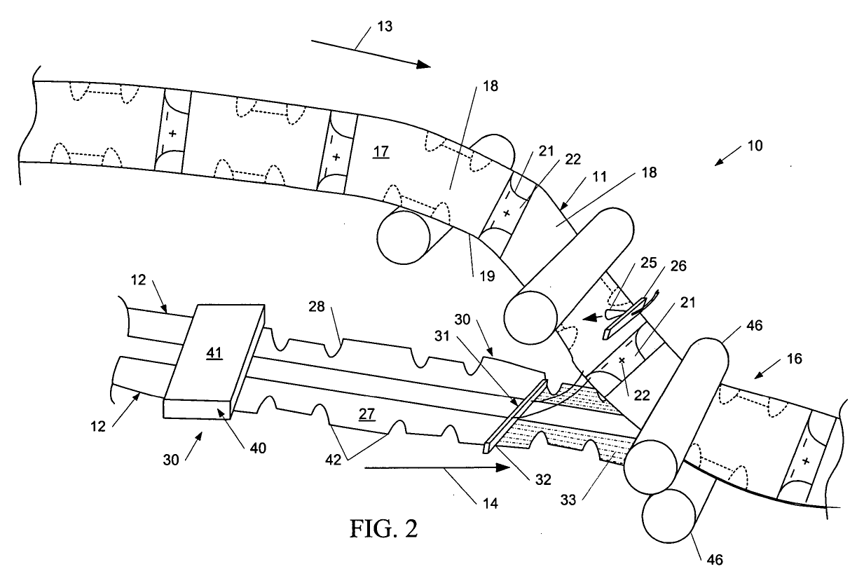

Referring now to the drawings in which like numerals indicate like parts through the several views, FIGS. 1A-2 illustrate various embodiments of the system and method for forming laminated cartons according to the principles of the present invention. The system generally comprises a laminating line or system, indicated at 10 in FIGS. 1A-2. A series of material webs or sheets, generally including at least a first web 11, and a second web 12, may be conveyed through the laminating line of system 10, with each of the first and second web being conveyed along a separate path of travel indicated by arrows 13 and 14, respectively, toward a laminating station 16. The first and second webs each can be formed from various types of carton materials including paperboard, cardboard, and other paper products, as well as plastics or other synthetic materials as will be known and understood by those skilled in the art.

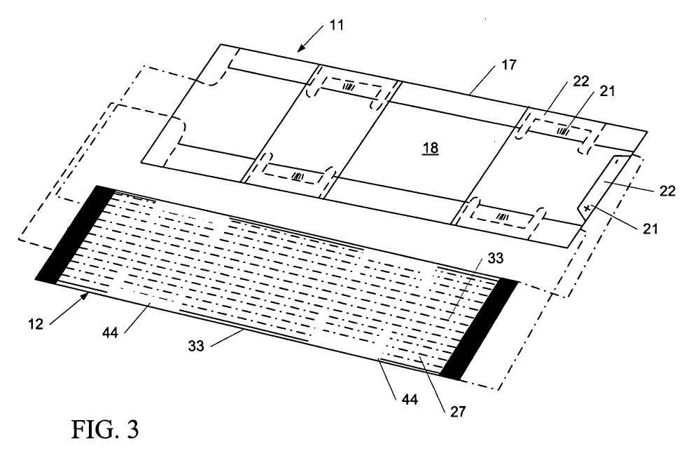

Typically, the first web 11 may be a printed web having graphics, text, or combinations thereof, typically printed along an upper or first surface 17, as indicated in FIG. 1B, typically separated or repeated in sections or segments, as indicated at 18 in FIG. 1B, corresponding to carton blanks that will be later formed. The first web also can include printing or graphics along its lower, second or bottom surface 19 as so desired. Other indicia such as ink marks or registration marks, indicated at 21 in FIGS. 2 and 3, also can be applied in white or unprinted spaces 22 along the upper surface of the first web, at points corresponding to flap portions along which the later formed cartons will be folded and attached together. As illustrated in FIGS. 1A-2, a sensor 25 generally may be mounted along the path of travel 13 of the first web 11 in a position to read the print, registration marks, or other indicia printed on at least one surface, typically on the upper surface 17, of the first web 11. For example, in addition to reading print or registration marks, the sensor can be programmed to detect on the first web changes in color (e.g., a transition from a white, unprinted section 22 of the web to a printed section 18), color blocks, or various other indicia that would indicate side edges, fold points, and/or leading or trailing edges of what will later be the assembled cartons. The sensor may be a photoelectric sensor, such as manufactured by Eltromat, or other similar type sensor or detector, and may be mounted on a carriage or support so as to enable movement or adjustment of the position across the width of the first web as desired or needed.

Approximately simultaneously with the movement of the first web 11 toward the laminating station 16, the second web 12 (FIGS. 1A-2) may be conveyed along its path of travel 14 toward the laminating station 16. The second web 12 can be formed from the same or similar materials to the first web, i.e., a paperboard, cardboard or similar product, and/or also can be formed from various synthetic or other known reinforcing materials. It is not necessary, however, that the first and second webs be formed of the same or similar materials, and can include other types of materials such as plastic strips, etc. As indicated in FIGS. 1A and 1B, the second web may be of a size or width approximately equal to that of the first web, although it also can be of a smaller or lesser size, and will include an upper surface 27 and a lower surface 28. As a further alternative, as shown in FIG. 2, the web can be formed as a series of one or more strips or ribbons that can be selectively attached to desired portions or sections of the first web for providing reinforcement or support at such desired areas.

As indicated in FIGS. 1A-2, one or more various operative assemblies or stations, generally indicated at 30, can be positioned along the path of travel 14 of the second web. Typically, such operative stations 30 may include at least an adhesive station 21, including one or more adhesive applicators or nozzles 32. As shown in FIGS. 1A-2, the adhesive applicators may be controlled to selectively apply beads or lines 33 of an adhesive material or glue, such as a cold set or hot melt adhesive as is conventionally used in the art, to the upper surface 27 of the second web. Typically, the adhesive application station 31 may be positioned as close as possible to the laminating station 16 so as to minimize the drying or setting of the adhesive before the first and second webs are laminated together. Those of ordinary skill in the art will understand that any adhesive material that will adhere two webs together may be used in the present invention.

Other operative stations 30 can include a print station 36 (FIG. 1B), which typically includes a print head 37 that is mounted on a carrier or guide and which can be moveable laterally across the lower surface 28 of the second web 12 in the direction of arrows 38 and 38′. The print head 37 may comprise an ink jet or similar type printer head that can apply graphics, text, or other printing at desired locations along the lower surface 28 of the second web. It is also possible for the second web to be pre-printed with text, graphics, etc. Still further, a cutting station 40 (FIG. 2), typically including a die cutter 41 or similar cutting mechanisms such as a knife blade or rotary cutter, can be positioned upstream from the adhesive station 31 in a position for engaging and cutting away selected portions 42 of the second web as indicated in FIG. 2. The cutaway portions 42 generally may correspond to portions or sections (shown in dashed lines 43) of the first web 11 that will be later cut and stripped away upon forming the carton blanks after the first and second webs have been laminated together. The operation of the cutter 41 may be controlled based upon tension of the second web to stamp or cut the web quicker or slower (i.e., after a delay) to ensure registration of the cut portions of each web downstream.

The operation of adhesive station 31, printing station 36, and cutting station 40 may be controlled by a system control for the laminating line 10 in response to detection or reading of various indicia such as registration or print marks 21, transitions between printing sections 18, or other indicia along the upper surface 17 of the first web 11 by the sensor 25. Thus, in the system of the present invention, the sensor 25 may be used to read and control the application of adhesive, as well as for controlling various other operations, including cutting, printing, and/or other operations along the second web, which is moving in timed relationship and registration with the first web. Each of the webs further will be under tension control, as understood in the art, to match the tension of each web within a close range with respect to the other web, based upon the weight of the web substrate, to substantially reduce or minimize curl in the webs and help ensure proper registration of the webs downstream. Adjustments to the tension of the webs generally will be made as needed during operation of the laminating line by control and adjustment of the feeding of the webs from their upstream supply roll.

As indicated in FIGS. 1B and 3, the adhesive applicators 32 may be controlled by the sensor 25 reading various programmed indicia printed along the first web so as to selectively apply the beads or lines 33 of the adhesive material at desired or selected points along and across the second web prior to lamination of the first and second webs together. For example, the adhesive applicators may apply a consistent line or band of adhesive, e.g., ¼ to 1 inch thick line of adhesive along portions of the second web corresponding to the cut, leading, and trailing edges and along the side edges of later formed carton blanks, so as to ensure against separation of the two webs or plies after lamination and cutting. At other points, such as in the middle of the second web, the adhesive may be applied more sporadically, such as by stopping and starting operation of the adhesive applicators to limit the application of the adhesive, in spots or along portions where a significantly reduced amount of adhesive is required to secure the laminated webs together in order to conserve or minimize the amount of adhesive used and thus avoid waste of the adhesive. Additionally, at areas that will be stripped or cut away from the later formed laminated carton blanks, the adhesive applicators can be controlled to stop the application of adhesive so that no adhesive will be applied to such areas or portions, such as indicated at 44 in FIG. 3 to further avoid waste or unnecessary application of adhesive. The amount of adhesive needed, as well as the locations for applying the adhesive, can be varied, and may be determined based on a variety of factors, including carton materials, adhesive materials, and desired strength of the carton.

The reading of the print or other indicia on the first web of the sensor also may be used in the present invention to control cutting and/or printing along the second web as needed or desired, typically in addition to the application of adhesive to the second web. It will be understood by those skilled in the art that various combinations of adhesive, cutting, and printing stations may be utilized in the present invention with the operation of each of the stations being controlled by the reading of print or other indicia along the upper surface of the first web by sensor 25.

A laminating station, as defined herein, includes any structures or process that can urge the first and second webs into adhesive contact. For example, as indicated in FIGS. 1A-2, the laminating station 16 may include a pair of compression or nip rolls 46 that apply a compression force so as to urge the first and second webs into tight adhesive contact. In this arrangement, a laminated sheet of carton material is formed, from which reinforced carton blanks 50 (FIG. 3) may be stamped or otherwise formed at a downstream cutting or stamping station (not shown). The process of the present invention further enables the reduction and conservation of adhesive material required for forming the resultant reinforced laminated cartons. The reduction may be achieved by controlling the application of the adhesive to the second web in response to detection of print or other indicia printed along the first web by a sensor. The sensor readings can also be used to control further operations conducted on the second web, including cutting or printing, with the second web thereafter being moved in timed relation into registration with the first web.

It will be understood by those skilled in the art that while the present invention has been discussed above with respect to various preferred embodiments and/or features thereof, numerous changes, modifications, additions and deletions can be made thereto without departing from the spirit and scope of the invention as set forth in the following claims.

What is claimed:

1. A method of forming laminated cartons, comprising:
moving a first web of a carton material along a first path of travel toward a laminating station;
moving a second web of carton material along a second path of travel toward the laminating station;
reading a series of indicia on the first web with a sensor and, in response, controlling the application of an adhesive material at selected locations along the second web; and
after the adhesive material has been applied to the second web, laminating the first and second webs together as they pass through the laminating station.

2. The method of claim 1 and further comprising controlling a printer for applying markings to the second web in response to reading the indicia on the first web.

3. The method of claim 1 and further comprising cutting the second web in response to reading the indicia of the first web.

4. The method of claim 3 and wherein cutting the second web comprises engaging the second web with a die cutter at selected locations therealong to match cut-out portions to be formed in the first web.

5. The method of claim 3 and wherein controlling the application of adhesive material to the second web comprises applying the adhesive material along uncut portions of the second web.

6. The method of claim 1 and wherein controlling the application of adhesive material to the second web comprises applying a desired pattern of the adhesive material at desired locations along the second web.

7. The method of claim 6 and further comprising applying a band of adhesive material across the second web at a portion of the second web corresponding to where a cut edge will be formed in the first and second webs after laminating.

8. The method of claim 6 and wherein applying a desired pattern of the adhesive material comprises selectively stopping and starting the application of adhesive to the second web to reduce the amount of adhesive material applied.

9. The method of claim 1 and further comprising cutting the laminated first and second webs to form laminated carton blanks.

10. The method of claim 1 and further using the sensor reading the indicia of the first web to control cutting of the second web and the application of the adhesive material to the second web.

11. The method of claim 1 and wherein reading a series of indicia comprises reading a leading edge of a contrast between different colors along the first web.

12. The method of claim 1 and wherein reading a series of indicia comprises reading at least one registration mark applied to the first web.

13. The method of claim 1 and wherein reading a series of indicia comprises reading at least one ink mark applied to the first web.

14. A method of forming a laminated sheet material, comprising:
moving a first web of material having indicia applied along an upper surface thereof along a first path of travel toward a laminating station;
moving a second web along a second path of travel toward the laminating station;
providing a sensor along the first path of travel of the first web in a position to detect and read the indicia applied to the upper surface of the first web;
detecting the indicia and signaling a controller to apply an adhesive material in a desired pattern along a surface of the second web; and
urging the first and second webs into adhesive contract at the laminating station to form the laminated sheet material.

15. The method of claim 14 and further comprising moving the first and second webs into a desired registration as they approach the laminating station.

16. The method of claim 14 and wherein applying a desired pattern of the adhesive material comprises selectively stopping and starting the application of adhesive to the surface of the second web to reduce the amount of adhesive material applied.

17. The method of claim 14 and further comprising applying a band of adhesive material across the second web at portions corresponding to locations along which cut edges will be formed in the first and second webs after laminating.

18. The method of claim 14 and further comprising cutting the laminated first and second webs to form laminated carton blanks.

19. The method of claim 14 and further comprising cutting the second web in response to reading the indicia applied to the first web.

20. The method of claim 19 and wherein controlling the application of adhesive material to the second web comprises applying the adhesive material along uncut portions of the second web.

21. The method of claim 14 and further comprising controlling a printer for applying markings to the second web in response to reading the indicia on the first web.
